(19) United States
(12) Patent Application Publication
(10) Pub. No.: US 2020/0017154 A1
(43) Pub. Date: Jan. 16, 2020

(54) METHOD FOR MANUFACTURING RESIN PANEL COMPONENT OF VEHICLE BODY

(71) Applicant: DAIHATSU MOTOR CO., LTD., Ikeda-shi, Osaka (JP)

(72) Inventors: Naoya IKEDA, Ikeda-shi, Osaka (JP); Manabu YAMADA, Ikeda-shi, Osaka (JP)

(73) Assignee: DAIHATSU MOTOR CO., LTD., Ikeda-shi, Osaka (JP)

(21) Appl. No.: 16/483,882

(22) PCT Filed: Mar. 15, 2018
(86) PCT No.: PCT/JP2018/010257

§ 371 Date: Aug. 6, 2019

(30) Foreign Application Priority Data
May 23, 2017 (JP) 2017-101634

(51) Int. Cl. B62D 65/14; B62D 29/04; B62D 65/02

(52) U.S. Cl. CPC B62D 65/14; B62D 65/06; B62D 65/026; B62D 29/04

(57) ABSTRACT

Manufacturing costs of a resin back door are reduced. After an adhesive is applied to an inner panel, the inner panel and outer panels are placed on top of each other, and relative positions between the outer panel and the inner panel are held by pressing an upper surface portion (first area) of the outer panel in a vehicle body vertical direction by using pressing members (first jigs) and pressing a spoiler (second area) of the outer panel in a vehicle body front-back direction by using pressing members (second jigs). Thereafter, the second jigs are removed from the outer panel, and the inner panel and the outer panel are heated while the upper surface portion of the outer panel is being pressed by the first jigs, thereby curing the adhesive.

### TECHNICAL FIELD

The present invention relates to a method for manufacturing a resin panel component of a vehicle body by joining an inner panel made from resin and an outer panel made from resin.

### BACKGROUND ART

Panel components (back door and the like) constituting a vehicle body are normally made from a steel plate. In some cases, however, the panel components are made from resin to reduce weight of the vehicle body, thereby reducing fuel consumption. Those panel components made from resin are assembled by bonding an inner panel made from resin and an outer panel made from resin (see Patent Document 1 cited below).

### CITATION LIST

### Patent Document

Patent Document 1: JP-A-2015-166245

### SUMMARY OF THE INVENTION

### Problems to be Solved by the Invention

When an inner panel and an outer panel are bonded, it is necessary to position both the panels. Normally, in many cases, positioning of the panels in an extending direction is performed by fitting a positioning pin provided on one panel into a positioning hole provided in the other panel, and positioning of the panels in a thickness direction is performed by pressing the outer panel by using a jig.

In some cases, however, it is difficult to provide a positioning pin or the like on the outer panel and the inner panel depending on a shape of a panel component. For example, in a back door illustrated in FIG. 12, a spoiler 101a protruding toward a rear side of a vehicle body (left side in the drawing) and an upper surface portion 101b extending from an upper end of the spoiler 101a to a front side of the vehicle body (right side in the drawing) are provided at an upper end of an outer panel 101. It is difficult to provide a positioning pin and a positioning hole in the spoiler 101a and the upper surface portion 101b of the outer panel 101, and therefore positioning of the upper surface portion 101b is performed by pressing the upper surface portion 101b by using jigs in two orthogonal directions. Specifically, the outer panel 101 is positioned with respect to an inner panel 102 in a vehicle body front-back direction by pushing the spoiler 101a of the outer panel 101 from the rear side of the vehicle body by using a first jig 110, and the outer panel 101 is positioned with respect to the inner panel 102 in a vehicle body vertical direction by pushing the upper surface portion 101b of the outer panel 101 to a lower side of the vehicle body by using a second jig 120. As described above, the inner panel 102 and the outer panel 101 are introduced into a heating furnace together with both the jigs 110 and 120 while the outer panel 101 is being pressed by both the jigs 110 and 120 and are then heated, and therefore an adhesive G is cured.

However, in this case, it is necessary to prepare the same number of first and second jigs 110 and 120 as workpieces that are to be introduced into a drying furnace, and therefore the number of jigs is increased, which causes an increase in manufacturing costs.

In view of this, an object of the present invention is to reduce manufacturing costs of a resin panel component.

### Solutions to the Problems

In order to achieve the object, the present invention provides a method for manufacturing a resin panel component of a vehicle body by joining an inner panel made from resin and an outer panel made from resin, the method including the steps of: applying an adhesive to at least one of the inner panel and the outer panel; placing the inner panel and the outer panel on top of each other and holding relative positions between the outer panel and the inner panel by pressing a first area of the outer panel in a direction substantially in parallel to a thickness direction of the first area by using a first jig and pressing a second area of the outer panel in a direction substantially orthogonal to the thickness direction of the first area by using a second jig: and removing the second jig from the outer panel and heating the inner panel and the outer panel while the first area of the outer panel is being pressed by the first jig to cure the adhesive.

As described above, in the present invention, the outer panel is pushed by the first jig and the second jig in two orthogonal directions, and the relative positions between the outer panel and the inner panel are held, and then the second jig is removed from the outer panel. At this time, a position in the direction substantially in parallel to the thickness direction of the first area (e.g., vehicle body vertical direction) is held by pressing the first area of the outer panel by using the first jig, and a position in a direction substantially orthogonal to the thickness direction of the first area (e.g., vehicle body front-back direction) is held by frictional force between the first jig and the first area of the outer panel. Thus, after the second jig is removed, both the panels are introduced into a drying step. With this, the second jig is not introduced into the drying step, and therefore it is possible to reduce the number of second jigs in the whole manufacturing line and therefore reduce costs. In particular, by mounting the second jig removed from the outer panel on an outer panel of a workpiece to be carried next, only a single second jig is needed. This makes it possible to remarkably reduce manufacturing costs.

### Effects of the Invention

As described above, according to the present invention, it is possible to reduce the number of jigs to be prepared in a manufacturing line of a resin panel component, and therefore it is possible to reduce manufacturing costs.

### BRIEF DESCRIPTION OF THE DRAWINGS

FIG. 1 is a flowchart of a manufacturing process of a back door.

FIG. 2(A) is a front view of an inner panel seen from a rear side of a vehicle body, and FIG. 2(B) is a B-B cross-sectional view of FIG. 2(A).

FIG. 3 is a plan view of a lower jig.

FIG. 4 is a plan view illustrating a state in which a lower outer panel is placed on an inner panel that is flatly placed.

FIG. 5(A) is an A-A cross-sectional view of FIG. 4, FIG. 5(B) is a B-B cross-sectional view thereof, FIG. 5(C) is a C-C cross-sectional view thereof, and FIG. 5(D) is a D-D cross-sectional view thereof.

FIG. 6(A) is a plan view illustrating a state in which a lower outer panel and an upper outer panel are placed on an inner panel that is flatly placed, and FIG. 6(B) is a B-B cross-sectional view of FIG. 6(A).

FIG. 7(A) is a bottom view of a lower upper-jig, and FIG. 7(B) is a side view thereof.

FIG. 8 is a plan view illustrating a state in which a lower outer panel and an upper outer panel are pressed by pressing members.

FIG. 9(A) is an A-A cross-sectional view of FIG. 8, FIG. 9(B) is a B-B cross-sectional view thereof, and FIG. 9(C) is a C-C cross-sectional view thereof.

FIG. 10 is a side view of FIG. 8 seen in an X direction.

FIG. 11(A) is a bottom view of an upper upper-jig, and FIG. 11(B) is a side view thereof.

FIG. 12 is a cross-sectional view illustrating a state in which an outer panel is pressed by jigs in two orthogonal directions according to a comparative example.

### DESCRIPTION OF EMBODIMENTS

Hereinafter, an embodiment of the present invention will be described with reference to the drawings.

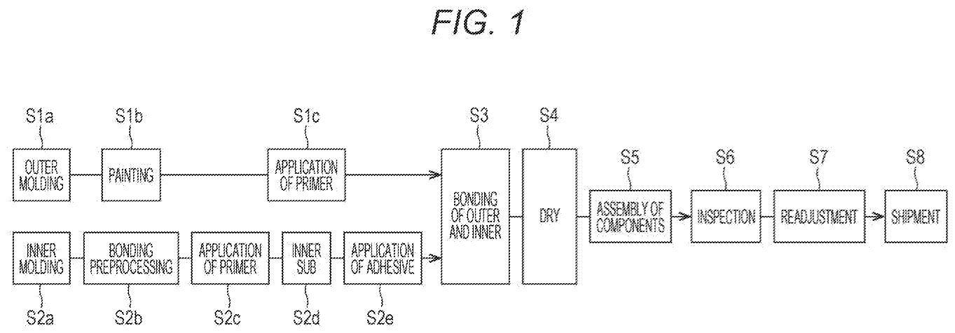

In the present embodiment, there will be described a case where a resin back door serving as a resin panel component of a vehicle body is manufactured in accordance with a process shown in FIG. 1. Specifically, first, an outer panel and an inner panel are injection molded with resin (Steps S1a and S2a). The outer panel is made from resin including no reinforcement and is made from, for example, polypropylene (PP). The inner panel is made from a resin material including a reinforcement and is made from, for example, polypropylene (PP) containing glass fibers. A mixing rate of glass fibers in the resin material of the inner panel is set to, for example, 30 wt % or more.

The outer panel is painted (Step S1b), and then a priming paint is applied to a bonding surface (Step S1c). Meanwhile, as to the inner panel, a bonding surface is subjected to preprocessing such as corona processing or plasma processing (Step S2b), and then a priming paint is applied to the bonding surface (Step S2c). Thereafter, various components are mounted on the inner panel (Step S2d).

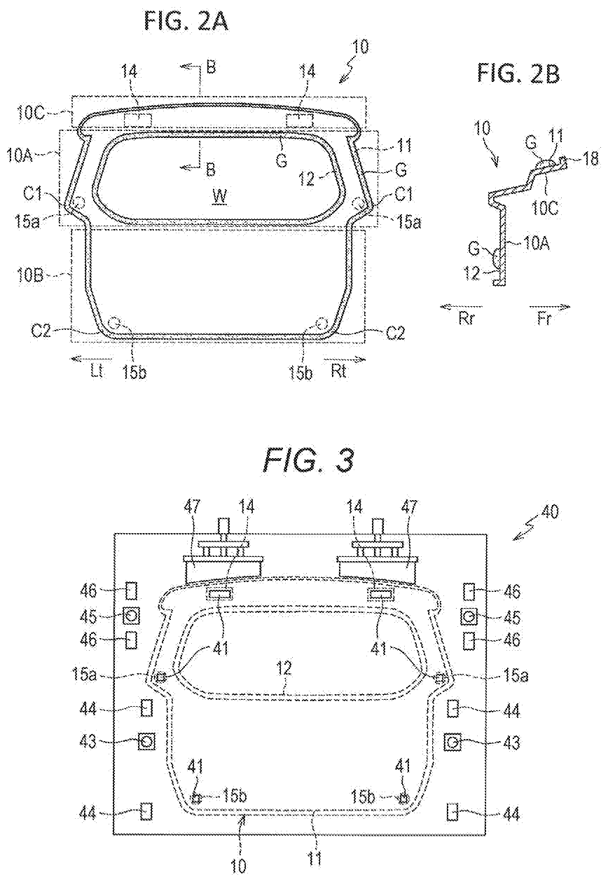

Then, an adhesive is applied to the bonding surface of the inner panel by a painting apparatus (e.g., painting robot) (not shown) (Step S2e). In the present embodiment, as illustrated in FIG. 2(A), a bonding surface 11 is provided on the whole outer circumference of an inner panel 10 and a bonding surface 12 is provided on the whole circumference portion of a window hole W of the inner panel 10, and an adhesive G is continuously applied to the whole circumferences of the bonding surfaces 11 and 12. The inner panel 10 has a glass mounting area 10A surrounding the window hole W, a lower area 10B provided below the glass mounting area 10A, and an upper area 10C provided above the glass mounting area 10A. Areas of the bonding surface 11 provided as the glass mounting area 10A and the lower area 10B face substantially a rear side of the vehicle body {a near side of the sheet of FIG. 2(A)}, and the bonding surface 11 provided in the upper area 10C faces substantially an upper side of the vehicle body {see FIG. 2(B)}. Note that the adhesive G may be applied not only to the inner panel as described above but also to the outer panel or to both the inner panel and the outer panel.

Thereafter, the inner panel and the outer panel are set on a jig while being placed on top of each other via the adhesive (Step S3 in FIG. 1). Then, the inner panel and the outer panel are introduced together with the jig into a heating apparatus, and the adhesive is cured (Step S4). Various components are mounted on an integrated component of the inner panel and the outer panel joined as described above (Step S5). Then, presence absence of distortion of a design surface of the outer panel and the like are inspected (Step S6), and, in a case where a defect is found in an inspection step, a readjustment step such as buffing is performed (Step S7). Then, a product determined as a good product is shipped (Step S8).

Hereinafter, among the above steps, the step in which the inner panel and the outer panel are placed on top of each other and are bonded (Step S3) will be described in detail.

First, the inner panel 10 (see FIGS. 2(A) and (B)) to which the adhesive G is applied is set on a lower jig 40 illustrated in FIG. 3. Specifically, the inner panel 10 is placed on the lower jig 40 while being held substantially horizontally so that a surface thereof directed toward a front side of the vehicle body faces downward. More specifically, the inner panel 10 is placed on a plurality of supports 41 while a positioning pin (not shown) provided on the lower jig 40 is being inserted into a hole (not shown) provided in the inner panel 10. At this time, the inner panel 10 is positioned by the positioning pin in a vehicle width direction and a vehicle body vertical direction (a horizontal direction and a vertical direction in FIG. 2) and is also positioned by the supports 41 in a vehicle body front-back direction (a direction orthogonal to the sheet of FIG. 2).

An attaching surface to which another member is attached is provided on the surface of the inner panel 10 directed toward the front side of the vehicle body {a surface on a back side of the sheet of FIG. 2(A)}. In the present embodiment, hinge attaching surfaces 14 and cushion rubber attaching surfaces 15a and 15b are provided on the inner panel 10 as the attaching surface. The hinge attaching surfaces 14 are provided at two positions distant from each other in the vehicle width direction in the upper area 10C of the inner panel 10. The cushion rubber attaching surfaces 15a are provided in the vicinity of both ends in the vehicle width direction in the glass mounting area 10A of the inner panel 10 and are particularly provided in the vicinity of corner portions C1 of the bonding surface 11 provided on the outer circumference of the inner panel 10. The cushion rubber attaching surfaces 15b are provided in the vicinity of both ends in the vehicle width direction in the lower area 10B of the inner panel 10 and are particularly provided in the vicinity of corner portions C2 of the bonding surface 11 provided on the outer circumference of the inner panel 10. The hinge attaching surfaces 14 and the cushion rubber attaching surfaces 15a and 15b are provided in an area different from areas in which the bonding surfaces 11 and 12 are provided and are provided in an area between the bonding surfaces 11 and 12 in the example illustrated in the drawing.

As illustrated in FIG. 3, the supports 41 of the lower jig 40 are provided at positions to support the hinge attaching surfaces 14 and the cushion rubber attaching surfaces 15a and 15b of the inner panel 10. That is, in a state in which the inner panel 10 is set on the lower jig 40, only the hinge attaching surfaces 14 and the cushion rubber attaching surfaces 15a and 15b of the inner panel 10 are supported by the supports 41 from below, and another area is not supported from below

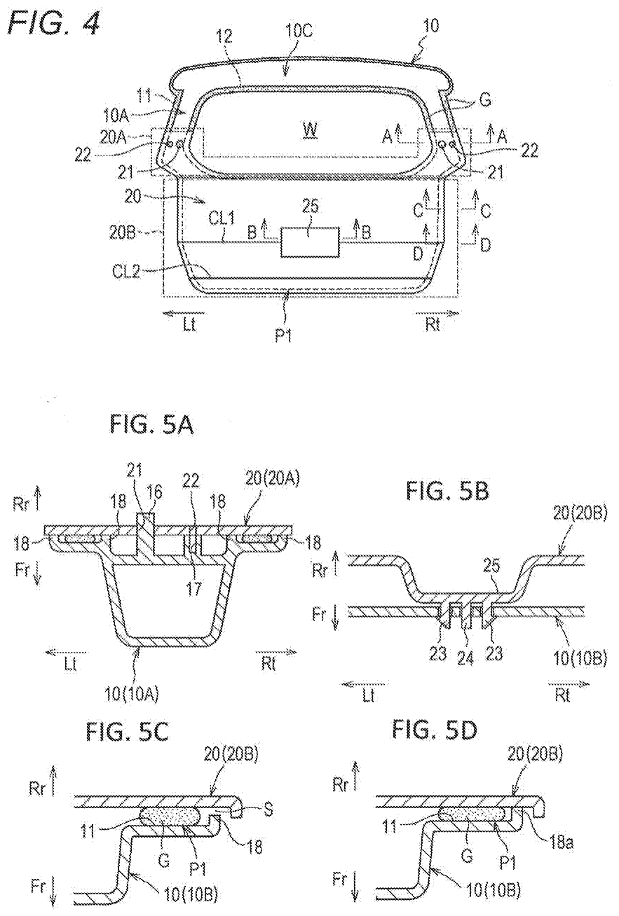

Next, as illustrated in FIG. 4, a lower outer panel 20 is placed on the inner panel 10 (The lower jig 40 is not illustrated in FIG. 4.). The lower outer panel 20 has a glass mounting area 20A surrounding a lower half part of the window hole W and a design surface area 20B provided below the glass mounting area 20A. The glass mounting area 20A becomes slightly lower than the design surface area 20B toward the front side of the vehicle body (a deeper side of the sheet). A character line (bent line) is provided in the design surface area 20B. and, in the example illustrated in the drawing, a character line CL1 bent in a valley shape (concave shape) and a character line CL2 bent in a mountain shape (convex shape) are provided (see FIG. 10).

When the lower outer panel 20 is placed on the inner panel 10, as illustrated in FIG. 5(A), bosses 16 provided in the glass mounting area 10A of the inner panel 10 are inserted into holes 21 provided in the glass mounting area 20A of the lower outer panel 20. With this, the lower outer panel 20 is positioned with respect to the inner panel 10 in the vehicle width direction and the vehicle body vertical direction. At this time, screw holes 17 provided in the inner panel 10 and holes 22 provided in the lower outer panel 20 are coaxially placed. The lower outer panel 20 is placed on the adhesive G applied to the bonding surfaces 11 and 12 of the inner panel 10, and the whole areas of the inner panel 10 and the design surface area 20B of the lower outer panel 20 are not in contact with each other.

Then, a worker pushes the design surface area 20B of the lower outer panel 20 downward (toward the inner panel 10) with his/her hands, and therefore the design surface area 20B of the lower outer panel 20 and the lower area 10B of the inner panel 10 are combined by engaging means. In the present embodiment, as illustrated in FIGS. 4 and 5(B), a recess 25 is provided in a substantially center portion of the lower outer panel 20, and claws 23 and a boss 24 protruding toward the inner panel 10 are provided on the recess 25. The worker pushes the recess 25 of the lower outer panel 20 downward, and therefore the claws 23 of the lower outer panel 20 are inserted into holes of the inner panel 10. With this, the claws 23 and the inner panel 10 are engaged, and the design surface area 20B of the lower outer panel 20 and the lower area 10B of the inner panel 10 are combined. At this time, the boss 24 of the lower outer panel 20 is fit into a hole provided in the inner panel 10, and therefore the lower outer panel 20 is positioned with respect to the inner panel 10 in the vehicle width direction.

When the worker pushes the lower outer panel 20 downward as described above, the inner panel 10 and the lower outer panel 20 may be brought into contact with each other and the adhesive G interposed between both the panels 10 and 20 may be discontinuous. In the present embodiment, ribs 18 protruding toward the lower outer panel 20 are provided along edges of the bonding surfaces 11 and 12 of the inner panel 10. Specifically, in the glass mounting area 10A of the inner panel 10, as illustrated in FIG. 5(A), the ribs 18 protruding toward the lower outer panel 20 are provided along the edges on both sides of the bonding surfaces 11 and 12. In the lower area 10B of the inner panel 10, as illustrated in FIGS. 5(C) and (D), the rib 18 is provided along an outer edge of the bonding surface 11. When the inner panel 10 and the lower outer panel 20 are approached, the above ribs 18 and the lower outer panel 20 abut against each other, and therefore a clearance in the vehicle body front-back direction is secured between the bonding surfaces 11 and 12 of the inner panel 10 and the lower outer panel 20. Thus, the adhesive G is securely held in the clearance.

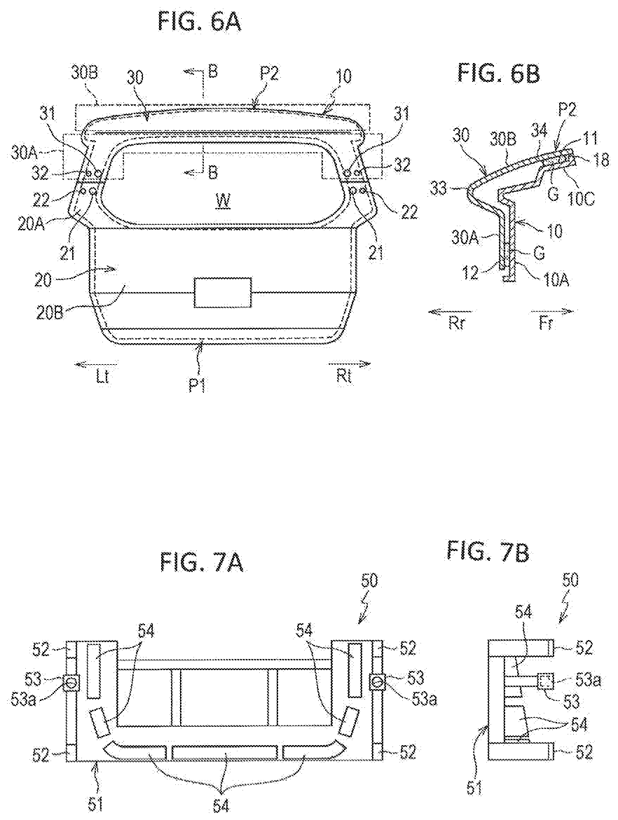

Next, as illustrated in FIGS. 6(A) and 6(B), an upper outer panel 30 is placed on the inner panel 10 (The lower jig 40 is not illustrated in FIGS. 6(A) and 6(B).). The upper outer panel 30 has a glass mounting area 30A surrounding an upper half part of the window hole W and a design surface area 30B provided above the glass mounting area 30A. As illustrated in FIG. 6(B), a spoiler 33 (second area) bent to swell toward the rear side of the vehicle body and an upper surface portion 34 (first area) extending from an upper end of the spoiler 33 to the front side of the vehicle body are provided in the design surface area 30B. An area extending from a lower end of the spoiler 33 of the design surface area 20B to a lower side of the vehicle body serves as the glass mounting area 30A.

When the upper outer panel 30 is placed on the inner panel 10, bosses provided in the glass mounting area 10A of the inner panel 10 are inserted into holes 31 provided in the glass mounting area 30A of the upper outer panel 30. which is similar to the case illustrated in FIG. 5(A). With this, the upper outer panel 30 is positioned with respect to the inner panel 10 in the vehicle width direction and the vehicle body vertical direction. At this time, screw holes provided in the inner panel 10 and holes 32 provided in the upper outer panel 30 are coaxially placed. As illustrated in FIG. 6(B), the rib 18 is provided along the outer edge of the bonding surface 11 in the upper area 10C of the inner panel 10 in order to secure a bonding clearance between the upper outer panel 30 and the inner panel 10.

Thereafter, the glass mounting areas 20A and 30A of the lower outer panel 20 and the upper outer panel 30 and the glass mounting area 10A of the inner panel 10 are combined by engaging means. In the present embodiment, screws serving as engaging means are engaged with the screw holes 17 {see FIG. 5(A)} in the glass mounting area 10A of the inner panel 10 via the holes 22 and 32 of the outer panels 20 and 30, and therefore the glass mounting areas 20A and 30A of the outer panels 20 and 30 and the glass mounting area 10A of the inner panel 10 are combined. Thereafter, glass to which an adhesive is applied is placed in the glass mounting areas 20A and 30A of the outer panels 20 and 30 (not shown). At this time, the glass mounting areas 20A and 30A of the outer panels 20 and 30 are covered by a non-transparent portion of glass and are therefore not seen from the outside.

In a state in which the inner panel 10 and the outer panels 20 and 30 are combined by the screws as described above, substantially the whole areas of both the panels 10 and 20 are not in contact with each other in a bonding area P1 of the design surface area 20B of the lower outer panel 20 and the inner panel 10. Specifically, as illustrated in FIG. 5(C), a clearance S in the vehicle body front-back direction is formed in substantially the whole area between the design surface area 20B of the lower outer panel 20 and the rib 18 in the lower area 10B of the inner panel 10. Meanwhile, protrusions 18a protruding more than another area toward the lower outer panel 20 are provided in a part of an area of the rib 18 in the lower area 10B of the inner panel 10 (see FIG. 10). As illustrated in FIG. 5(D), the protrusions 18a abut against an area in the vicinity of the character line CL of the lower outer panel 20.

Further, substantially the whole areas of both the panels 10 and 30 are not in contact with each other in a bonding area P2 between the design surface area 30B of the upper outer panel 30 and the inner panel 10, and, in the example in the drawings, the whole areas are not in contact with each other. Specifically, as illustrated in FIG. 6(B), a clearance in the vehicle body vertical direction is formed between the upper surface portion 34 of the upper outer panel 30 and the rib 18 in the upper area 10C of the inner panel 10.

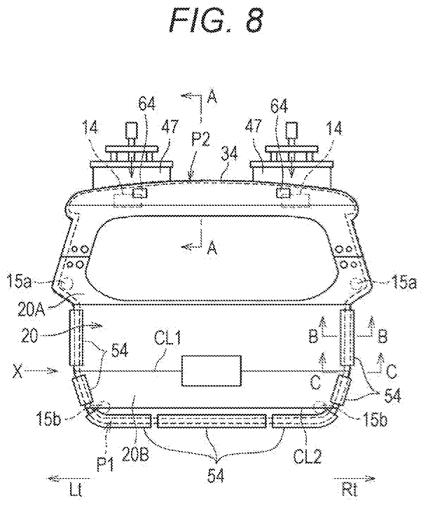

Next, a lower upper-jig 50 illustrated in FIG. 7 is mounted on the lower jig 40 (see FIG. 3). The lower upper-jig 50 includes a frame 51, legs 52 provided at four corners of the frame 51, positioning members 53, and pressing members 54. The lower upper-jig 50 is lowered, and the legs 52 of the lower upper-jig 50 are placed on mounting stands 44 (see FIG. 3) of the lower jig 40 while positioning pins 43 (see FIG. 3) of the lower jig 40 are being inserted into holes 53a of the positioning members 53. With this, as illustrated in FIG. 8, the pressing members 54 provided on the lower upper-jig 50 press an outer circumference portion of the design surface area 20B of the lower outer panel 20 from above and push the outer circumference portion into a predetermined position (A part of the lower jig 40 is not illustrated in FIG. 8). The bonding area P1 of both the panels 10 and 20 on the design surface of the lower outer panel 20 is pressed by the pressing members 54. However, areas in the vicinity of the character lines CL1 and CL2 on the design surface of the lower outer panel 20 are not pressed by the pressing members 54. A pushing depth of the lower outer panel 20 performed by the pressing members 54 can be adjusted by interposing shims (not shown) between the legs 52 of the lower upper-jig 50 and the mounting stands 44 of the lower jig 40. In this state, the lower upper-jig 50 and the lower jig 40 are fixed by a clamp mechanism (not shown).

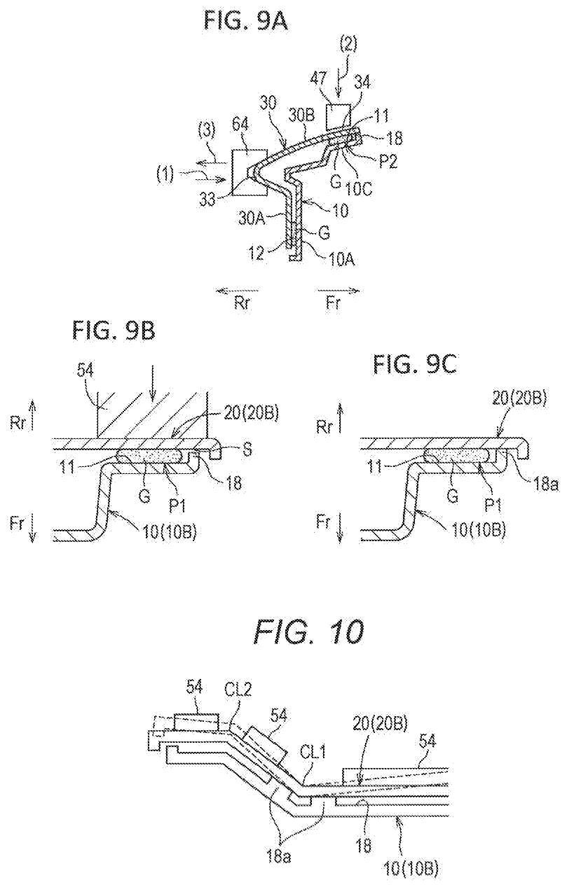

At this time, at least all areas in the design surface area 20B of the lower outer panel 20, the areas being pressed by the pressing members 54, are held while not being in contact with the inner panel 10. Specifically, as illustrated in FIG. 9(B), the areas in the design surface area 20B of the lower outer panel 20, the areas being pressed by the pressing members 54 of the lower upper-jig 50, are pushed into a predetermined position. At this time, the lower outer panel 20 and the rib 18 of the bonding surface 11 of the inner panel 10 are held while not being in contact with each other, and the clearance S in the vehicle body front-back direction is maintained therebetween. Meanwhile, as illustrated in FIG. 9(C), an area in the vicinity of the valley-shaped character line CL1 in the design surface area 20B of the lower outer panel 20 is not pressed by the pressing members 54 and is supported by the protrusions 18a of the rib 18 of the inner panel 10 from below. That is, the whole contact area P1 of the design surface 20B of the lower outer panel 20 and the inner panel 10 is not in contact with the inner panel 10, except for contact portions with the protrusions 18a of the rib 18 of the inner panel 10.

As exaggeratedly indicated by a dotted line in FIG. 10, areas on both sides of the character line CL1 of the lower outer panel 20 immediately after molding (before bonding) become sharper than desired positions due to an influence of mold shrinkage. Therefore, as indicated by a solid line in FIG. 10, the areas on both the sides of the character line CL1 of the lower outer panel 20 are pushed downward by the pressing members 54 while the area in the vicinity of the character line CL1 is being supported by the protrusions 18a of the rib 18 of the inner panel 10 from below. Thus, it is possible to make correction so that the lower outer panel 20 has a desired shape.

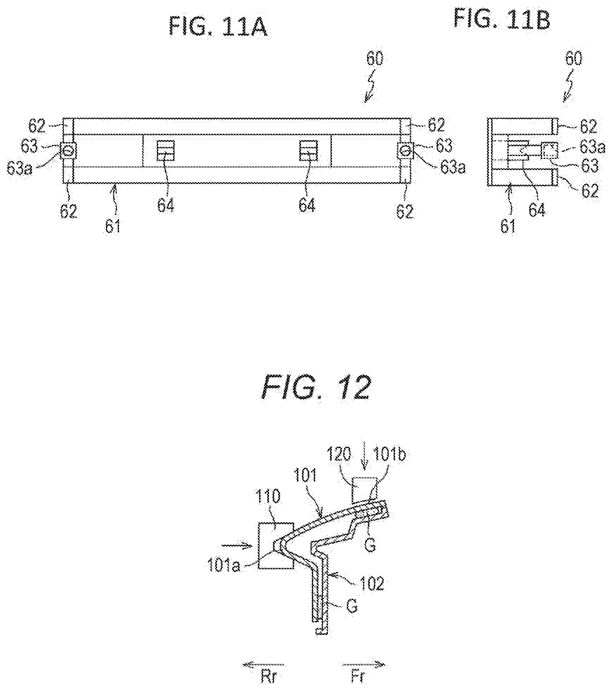

Next, an upper upper-jig 60 illustrated in FIG. 11 is mounted on the lower jig 40 (see FIG. 3). The upper upper-jig 60 includes a frame 61, legs 62 provided at four corners of the frame 61, positioning members 63, and pressing members 64. The upper upper-jig 60 is lowered, and the legs 62 of the upper upper-jig 60 are placed on mounting stands 46 (see FIG. 3) of the lower jig 40 while positioning pins 45 (see FIG. 3) of the lower jig 40 are being inserted into holes 63a of the positioning members 63. With this, the pressing members 64 provided on the upper upper-jig 60 press the upper outer panel 30 from above and push the upper outer panel 30 into a predetermined position. In the present embodiment, as illustrated in FIG. 9(A), the pressing members 64 (second jigs) of the upper upper-jig 60 press the spoiler 33 (second area) of the upper outer panel 30 in a direction substantially orthogonal to a thickness direction of the upper surface portion 34 (first area) (the vehicle body front-back direction in the example illustrated in the drawing) {see an arrow (1) in FIG. 9(A)}. At this time, the design surface area 30B of the upper outer panel 30 and the upper area 10C of the inner panel 10 are held while the whole areas thereof are not being in contact with each other. A pushing depth of the upper outer panel 30 performed by the pressing members 64 can be adjusted by interposing shims (not shown) between the legs 62 of the upper upper-jig 60 and the mounting stands 46 of the lower jig 40. Thus, the upper outer panel 30 and the inner panel 10 are positioned in the vehicle body front-back direction. In this state, the upper upper-jig 60 and the lower jig 40 are fixed by a clamp mechanism (not shown).

Thereafter, the upper outer panel 30 is pushed in the horizontal direction by pressing members 47 provided on the lower jig 40. Specifically, as illustrated in FIGS. 8 and 9(A), the pressing members 47 (first jigs) press the upper surface portion 34 (first area) of the upper outer panel 30 in a direction substantially in parallel to the thickness direction of the upper surface portion 34 (the vehicle body vertical direction in the example illustrated in the drawing) {see an arrow (2) in FIG. 9(A)}. With this, the upper outer panel 30 is positioned with respect to the inner panel 10 in the vehicle body vertical direction. In the examples illustrated in the drawings, the bonding area P2 of the design surface of the upper outer panel 30 and the inner panel 10 is pressed by the pressing members 47. With this, a position and a shape of the upper outer panel 30 are corrected. At this time, the design surface area 30B of the upper outer panel 30 is held while the whole area thereof is not being in contact with the inner panel 10.

Thus, the inner panel 10, the lower outer panel 20, and the upper outer panel 30 are held by the lower jig 40, the lower upper-jig 50, and the upper upper-jig 60. Thereafter, the upper upper-jig 60 is removed from the lower jig 40 {see an arrow (3) in FIG. 9(A)}. At this time, the upper surface portion 34 of the upper outer panel 30 is pressed by the pressing members 47 from the upper side of the vehicle body, and therefore the upper surface portion 34 is held in the vehicle body vertical direction, and, in addition, the upper surface portion 34 is also held in the vehicle body front-back direction because of friction with the pressing members 47. Therefore, even in a case where the upper upper-jig 60 is removed, relative positions between the upper outer panel 30 and the inner panel 10 are held in two orthogonal directions (vehicle body vertical direction and vehicle body front-back direction). In particular, in the present embodiment, the glass mounting area 30A of the upper outer panel 30 and the glass mounting area 10A of the inner panel 10 are combined by screws in advance, and therefore, even in a case where the upper upper-jig 60 is removed, it is possible to securely hold the relative positions between the upper outer panel 30 and the inner panel 10.

Thereafter, the inner panel 10 and the outer panels 20 and 30 are introduced into a drying furnace while being mounted on the lower jig 40 and the lower upper-jig 50 and are then heated, and therefore the adhesive G is cured. Thus, the panel component (back door) is completed.

The upper upper-jig 60 is removed before a drying step as described above, and therefore it is possible to reduce the number of upper upper-jigs 60 in use and therefore reduce costs. In the present embodiment, although a plurality of lower jigs 40 and lower upper-jigs 50 is provided in consideration of takt time of the drying step, only a single upper upper-jig 60 is provided and is used only to position the upper outer panel 30 in the vehicle body front-back direction. Specifically, the upper upper-jig 60 is mounted on the lower jig 40 and positions the upper outer panel 30 in the vehicle body front-back direction, and the upper surface portion 34 of the upper outer panel 30 is pressed by the pressing members 47 of the lower jig 40. and then the upper upper-jig 60 is removed from the lower jig 40 and is mounted on a lower jig 40 of the next workpiece. Note that a plurality of upper upper-jigs 60 may be provided, and, also in this case, the upper upper-jigs 60 are not introduced into a drying step, and therefore it is possible to reduce the number of upper upper-jigs 60 in use as compared to typical techniques.

In the present embodiment, as described above, sandwiching and pressurizing the bonding areas P1 and P2 of the design surface areas 20B and 30B of the outer panels 20 and 30 and the inner panel 10 are eliminated, and the bonding areas P1 and P2 are pressed by jigs (pressing members 54 and 47) only on the side of the outer panels 20 and 30 without being supported on the inner panel 10 side (see FIG. 9). With this, dimensions of the inner panel 10 are not corrected by jigs, and therefore it is possible to reduce a heating temperature in the subsequent drying step and set the heating temperature to, for example, 50° C. or less. Further, the pressing members 54 and 47 only need to push the outer panels 20 and 30 with force enough to correct only the outer panels 20 and 30, and therefore it is possible to reduce pressure to be applied to the design surfaces of the outer panels 20 and 30 by the pressing members 54 and 47. As described above, the heating temperature in the drying step is reduced, and the pressure applied to the design surfaces by the pressing members is also reduced, and therefore distortion of the design surfaces of the outer panels 20 and 30 is restrained. Thus, man-hour in the subsequent inspection step and readjustment step is reduced. This makes it possible to shorten takt time. Manufacturing takt time of the back door is shortened as described above, and therefore it is also possible to start manufacturing a back door in the middle of manufacturing a vehicle body main body (e.g., when a painting step is terminated) and mount the back door on the vehicle body main body in an assembling step of the vehicle body, i.e., to perform so-called sequential production.

Further, it is unnecessary to manage dimensions of the glass mounting areas 20A and 30A of the outer panels 20 and 30 with high accuracy, and therefore the glass mounting areas 20A and 30A do not need to be pressed and corrected by the upper jigs 50 and 60. In the present embodiment, the glass mounting areas 20A and 30A of the outer panels 20 and 30 and the glass mounting area 10A of the inner panel 10 are combined by screws. With this, the glass mounting areas 20A and 30A of the outer panels 20 and 30 do not need to be pressed by the jigs, and therefore it is possible to simplify the upper jigs 50 and 60 that press the outer panels 20 and 30. This leads to cost reduction.

The present invention is not limited to the above embodiment. For example, a case where the second area of the outer panel 30 is the spoiler 33 has been described in the above embodiment, but the present invention is not limited thereto. The second area may be a substantially flat surface substantially orthogonal to the vehicle body front-back direction.

Further, a case where the bonding area of the inner panel and the outer panel is not supported from below in a bonding step has been described in the above embodiment, but the present invention is not limited thereto. The present invention may be applied to a case where the bonding area of both the panels is sandwiched and pressurized as in typical techniques.

This application claims priority from Japanese Patent Application No. 2017-101634 filed on May 23, 2017 with the Japan Patent Office, and the entire contents of Japanese Patent Application No. 2017-101634 are hereby incorporated in this application by reference.

The above description of the specific embodiments of the present invention has been presented for the purpose of exemplification. The description is not intended to be exhaustive or limit the present invention to the described embodiments. It is apparent to persons skilled in the art that various modifications and changes can be made based on the above description.

### DESCRIPTION OF REFERENCE SIGNS

10 Inner panel
10A Glass mounting area
10B Lower area
10C Upper area
11, 12 Bonding surface
20 Lower outer panel
20A Glass mounting area
20B Design surface area
30 Upper outer panel
30A Glass mounting area
30B Design surface area
33 Spoiler (second area)
34 Upper surface portion (first area)
40 Lower jig
41 Support
47 Pressing member (first jig)
50 Lower upper-jig
54 Pressing member
60 Upper upper-jig
64 Pressing member (second jig)
G Adhesive
P1, P2 Bonding area
W Window hole

1. A method for manufacturing a resin panel component of a vehicle body by joining an inner panel made from resin and an outer panel made from resin, the method comprising the steps of:
applying an adhesive to at least one of the inner panel and the outer panel;
placing the inner panel and the outer panel on top of each other and holding relative positions between the outer panel and the inner panel by pressing a first area of the outer panel in a direction substantially in parallel to a thickness direction of the first area by using a first jig and pressing a second area of the outer panel in a direction substantially orthogonal to the thickness direction of the first area by using a second jig; and
removing the second jig from the outer panel and heating the inner panel and the outer panel while the first area of the outer panel is being pressed by the first jig to cure the adhesive.
